(19) United States
(12) Patent Application Publication
(10) Pub. No.: US 2005/0028153 A1
(43) Pub. Date: Feb. 3, 2005

(54) Method and system for replacing fee-based software

(76) Inventor: Glen J. Anderson, Sioux City, IA (US)

Correspondence Address: GATEWAY, INC.;ATTN: SCOTT CHARLES RICHARDSON, 610 GATEWAY DRIVE, MAIL DROP Y-04, N. SIOUX CITY, SD, 57049, US

(21) Appl. No.: 10/631,101

(22) Filed: Jul. 31, 2003

(51) Int. Cl. G06F 9/44; G06F 17/00

(52) U.S. Cl. 717/168; 717/174; 705/500

(57) ABSTRACT

A method, system, and computer-readable medium for providing alternative software to users of fee-based software products, detects the software residing on a user's computer, determines the expiration date of the fee-based software, offers replacement, complementary, and/or supplementary software based on this information, and downloads the replacement software to the computer of the user as requested by the user.

### FIELD OF THE INVENTION

The present invention relates to providing software for a computer. More particularly, the present invention is directed to a method, system, and computer-readable medium for offering software for a computer based on features of the software residing on the computer.

### BACKGROUND OF THE INVENTION

Customarily, when an individual or company buys a personal computer, the computer is pre-loaded with various software programs serving a variety of functions (e.g., system tools, word processing, databases, network-related, teaching, recreational, etc.). Many of these programs are licensed by the software provider for perpetual use. Nevertheless, certain software programs are licensed only for specific time periods or require renewal in order for them to be effective, i.e., Norton Anti-virus. These programs require the user to pay a renewal license fee to update the program and/or continue use after the expiration of the current license term.

Various computer companies are moving toward selling their software products on a “fee-based” system. In this system, users pay recurring fees at certain time intervals to continue use, i.e. renew a license, of the software. As an example, a business may need to pay an annual fee for use (license) of a software product or a software suite. This is sometimes referred to as a “true-up” fee.

In the case of software being installed on a user's computer for perpetual use, it is less likely that a computer user would seek an alternative to that software or would upgrade the software. In the case of a fee-based software product (or system) such as described above, it is likely that a user would want to upgrade the software or replace the software at the time a fee payment is due. In this regard, if the fee is not paid, the user will be unable to make further use of the software. This could impact negatively on a personal user's system or commercial use of products that may be indispensable to a company's business. In order to continue use of the existing software, the user must pay the renewal or update/upgrade fee. Alternatively, the user must search for replacement software and figure out the expiration date(s) of the existing software.

It is known to offer software to a computer user based on certain other factors, such as the marketing profile of the user, the hardware configuration of a machine, or based on a computer user's registration of a certain software product.

Moreover, there is a need for a method and system for providing an alternative to fee-based software based on the software's characteristics, especially on or about the time a software license expires when a true-up fee is due.

### SUMMARY OF THE INVENTION

The present invention comprises a method, system and computer-readable medium for providing an alternative to fee-based software. The present invention detects the software on a user's computer and, at certain time intervals related to when a software product will expire and a renewal payment will be due, provides alternative software products for purchase.

In one embodiment, the software offered is replacement software, complementary software, and/or supplementary software. The method and system detect the type of software on the user's computer and compare the aspects of the software program with a database of rules to provide criteria for the software offering. The criteria are used to customize the offer to particular software products.

It is to be understood that the foregoing general description and the detailed description are exemplary, but not restrictive of the invention.

### BRIEF DESCRIPTION OF THE DRAWINGS

The present invention is best understood from the following detailed description when read in connection with the accompanying drawings. It is emphasized that, according to common practice, the various features of the drawings are not to scale; rather, the dimensions of the various features are arbitrarily expanded or reduced for clarity. Included in the drawings are the following figures.

FIG. 1 is a schematic showing the process steps of the present invention.

FIG. 2 is a schematic showing the operation of the present invention with a new computer download or web-based software purchase.

FIG. 3 is a schematic showing operation of the present invention with a purchase of software and use of detection software.

### DETAILED DESCRIPTION OF THE INVENTION

The present invention comprises a method, system, and computer-readable medium for providing alternative software products to computer users based upon the time when a fee must be paid for existing programs to be renewed or updated/upgraded for continued use. In its most general form, the present invention detects the software configuration on a user's computer and determines when software program licenses will expire or programs will need to be updated/upgraded. It then offers the user replacement, complementary, and/or supplementary software.

For purposes of the present invention, “fee-based” software comprises software products that require payment of a fee to renew a license to use the software and/or for an update or upgrade of the software. Also, for purposes of the present invention, “expiration date” of software means the software license expiration date, a required update or upgrade date, or any other date on which a user is required to pay a fee to continue existing use or update or upgrade use of a software program. This includes, without limitation, continuing meaningful use of a software program, i.e., even if a software program is useable after the expiration date, use of it would not be meaningful if the version authorized cannot perform the functions desired by the user.

The method and system of the present invention use computer software and hardware to determine the software configuration on the user's computer. With this information, the system determines the expiration dates of fee-based software and presents an offer(s) of software to the user based on those dates and the characteristics of the user's software configuration. Detection (or monitoring) software programs loaded or interacting with the user's computer may enable these determinations. Detection may be performed by the software automatically or manually through interface with the user, a software vendor, a computer OEM, or any other entity providing software or monitoring software usage.

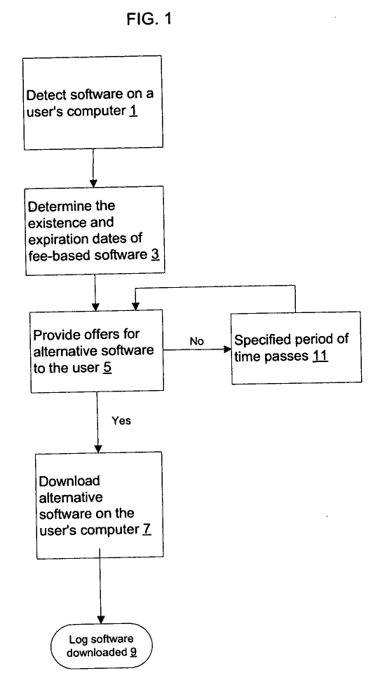

With reference to an exemplary embodiment of the invention in FIG. 1, software is detected on the user's computer at step 1 and the software determines the existence of fee-based software and the expiration dates of licenses of that software at step 3. The system provides an offer for alternative software to the user at step 5. If the user accepts the offer for alternative software, in step 7, the software is downloaded onto the user's computer, and in step 9, the system logs the download of the software on a system database or a local database on the user's machine. If the user rejects the offer for alternative software, a specified period of time passes, shown in step 11, and the offer is provided once again.

The user may install detection software that monitors software on a user's computer. The detection software determines the expiration dates of licenses to existing fee-based software and other related information about these software products. The software then notifies a potential vendor of (alternative software) of that information. The detection software that monitors software applications on a user's computer can, for example, detect the date of installation by monitoring the registry of the computer, for example, the Windows Registry. Alternatively or in addition, it can monitor the file types used by each product and, in that way, it receives data about the duration of the license agreement for the product. Further, detection software can query the user about expiration dates.

In one instance, the data or a software product is made available, for example, to an OEM of personal computers, once a new system is provided. Specifically, a vendor of personal computers sells a computer with a one-year productivity software suite. The computer vendor uses this program information (that the fee-based productivity suite license will expire in one year) to update a database maintaining the information such that it can be accessed by the vendor's computer system. The database may be maintained on the user's computer, the vendor's system, or both. This information allows the vendor itself to offer alternative software based on the expiration date or other characteristics of the software as described in more detail below.

Alternatively, a vendor sells a user a software product that is downloaded via the Internet or by any other suitable means and, by this sale and download, the vendor determines when various pieces of software, including the downloaded software, expire. The vendor that sells a user the software would be able to maintain in a database the expiration dates of the licenses and other information on the software and provide notification and software offers to the user at specific time intervals based on those expiration dates and other information on the software.

Detection software used in the present invention for monitoring software on a user's computer can be programmed using any suitable programming language, such as C, C++, Visual Basic, Java, etc. The detection software module can run constantly in the background of a machine or can run at specific times, such as during boot-up of a computer or on a specific time interval (e.g., every few hours, every day, every week, etc.)

In one embodiment, the detection software is accessed via an application service provider's (ASP's) website such that the software and database of information are maintained on the ASP's server. A user accesses the website or allows access to its system and the software detects information about the software configuration.

The detection software can be placed on a computer at the time of purchasing a new computer, via download from an Internet website or via any other computer network. Alternatively, detection software may be installed separately as part of a monitoring software package purchased or authorized to be installed by the computer user. This type of monitoring software assists users with various software upgrades (downloads), detects expiration dates, and stores this information (e.g., in a database), as described above. Often, the software vendor that uses the monitoring software to make software offers is not the author of the software being detected.

The database of information on a user's software configuration contains information about specific applications in addition to the expiration dates, including, without limitation, the date of download or other installation, file types assigned to the application, frequency of use, etc. In addition, information about the applications in general can be stored. For instance, the database can store data on the tasks that are accomplished by each program and the typical lease period for different applications, such as anti-virus software that may have a specific license term. Thus, by suitable access to such information, a software vendor or other entity using the present invention can offer software products that are complementary to, supplementary to, and/or replacements of the software applications that are set to expire.

Preferably, the system uses rules to determine what software should be offered to a user. These rules link the software applications, the dates of expiration, the frequency of use, the types of software, and any other relevant feature to the software offerings appropriate for the user (based on existing software products). As an example of a rule, based on the expiration date of an anti-virus program (and renewal fee being due) and the characteristics of the program (e.g., the tasks it performs), it will prompt the system to offer a replacement software product (anti-virus program), a complementary product (a personal firewall program), and/or a supplementary product (a system diagnostic and repair program).

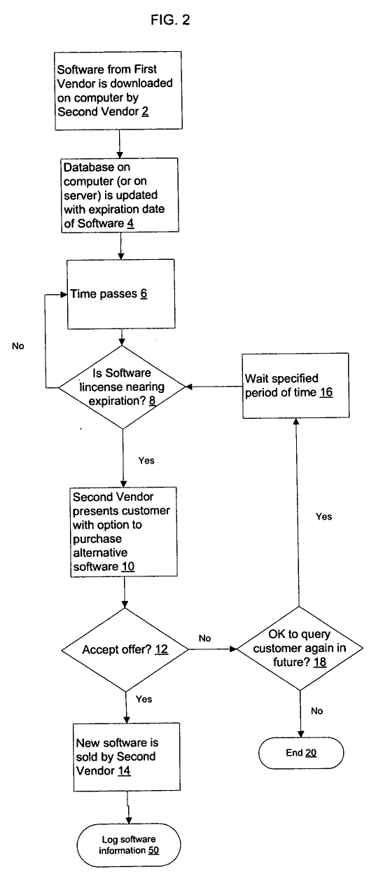

With reference to specific embodiments, in FIG. 2, the process of offering alternative software in the context of computer software downloads is shown schematically. Software from a first vendor is downloaded onto a user's computer by a second vendor at step 2. The database on the computer, or alternatively, on the server, is updated with the expiration date of the software that was installed (block 4.) As time passes (block 6), the system queries the user as to whether the software license is near expiration (block 8). If the user answers yes, or otherwise affirmatively, the vendor presents the user with the option to purchase alternative software (block 10). If the user accepts the offer (block 12), the new software is sold by the vendor to the user (block 14) and a log of that software being downloaded by the user is kept (block 50).

If the software is not nearing license expiration, time is allowed to pass (block 6) and the user is queried repeatedly until the software license is nearing expiration. The vendor presents the customer with the option to purchase alternative software 10. If the offer is not accepted (block 12), the system inquires as to whether the user authorizes it to question on the software again in the future (block 18). If the user refuses to be questioned again, the process finishes (block 20). If the user accepts future questioning, a specified period of time passes (block 16) and the query is provided again as to whether the software is nearing expiration (block 8).

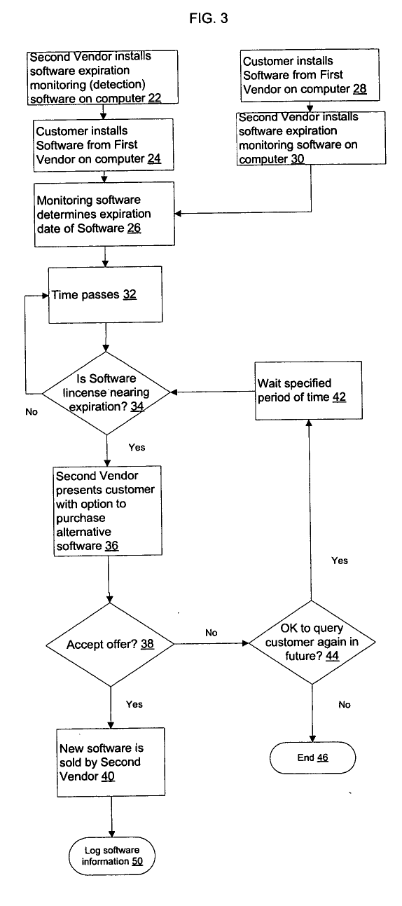

As shown in FIG. 3, the method and system of the present invention proceed with a second vendor (or other entity) installing software that monitors the expiration of other software on the computer (block 22). The user then installs additional software from a first vendor on the computer (block 24). The monitoring software determines the expiration date of the new software installed (block 26). Alternatively, the user (customer) installs a software product from a first vendor on the computer (block 28), and then a second vendor installs detection software that monitors other software on the computer (block 30).

After the detection software determines the expiration of the other software products (block 26), optionally, times passes (block 32) and the user is queried as to whether a software's license is near expiration (block 34). If the software is near expiration and the user answers the query with a yes or otherwise affirmatively, the second vendor presents the customer with an offer to purchase alternative software (this offer may be for replacement, supplementary, and/or complementary software) (block 36); the user is given the option to accept the offer for software (block 38). If the user accepts the software, the new software is sold by the vendor (block 40) and the information about the software download is logged into the system (block 50). If the user does not accept the offer for software, the system requests the user's authorization to query the user again in the future (block 44). If the user authorizes the future questioning, a specified period of time elapses (block 42) and the query as to whether the software licenses is nearing expiration (block 34) occurs again. If the user does not provide authorization to be queried in the future, the system ceases the process (block 46).

If in response to the query about whether the software license is near expiration (block 34), the user answers no or otherwise negatively, time passes (block 32) until the query about software expiration is provided again. The system then proceeds with software offers as described above.

While illustrated and described above with reference to certain specific embodiments, the present invention is nevertheless not intended to be limited to the details shown. Rather, the present invention is directed to a method and system for detecting characteristics of software on a user's computer and offering replacement, complementary, and/or supplementary products to fee-based software, and various modifications may be made in the details within the scope and range of equivalents of the description and without departing from the spirit of the invention.

1. A method for offering alternative software, comprising:
scanning a computer system of a user to detect software residing on a system of the user;
determining an expiration date for software residing on the computer; and
offering the user alternative software based on the expiration date of the software.

2. The method of claim 1, further comprising the step of monitoring the passage of time until the expiration date and transmitting a message to a software vendor at predetermined time intervals, wherein the software of the user was not authored by the software vendor and is detected by a monitoring program.

3. The method of claim 2, further comprising the step of providing the monitoring program on at least one of the computer of the user, a computer network, and a computer of the software vendor.

4. The method of claim 1, wherein the step of scanning the system comprises the step of detecting fee-based software.

5. The method of claim 1, further comprising, after the offering step, providing the alternative software to the user in response to receiving an affirmative response from the user.

6. The method of claim 1, further comprising, after the offering step, receiving a negative response from the user and renotifying the user of the offer for the alternative software at a specified time interval from the time of the negative response.

7. The method of claim 1, wherein the expiration date is determined by a monitoring program.

8. The method of claim 7, wherein the monitoring program resides on the computer of the user and determines the expiration date by scanning at least one of: the files corresponding to registration of the software by the user, file types associated with software, and an installation date of software.

9. The method of claim 1, wherein the determining step comprises querying the user on the expiration date of software and the offering step is based on a response to the query.

10. The method of claim 9, further comprising, after the offering step, receiving a negative response from the user and renotifying the user of the offer for the alternative software at a specified time interval from the time of the negative response.

11. The method of claim 1, further comprising storing information detected from the software in a database, and customizing alternative software offers based on the information in the database.

12. The method of claim 11, wherein the offering step comprises offering at least one of replacement software, complementary software, and supplementary software.

13. The method of claim 11, further comprising detecting software characteristics selected from the group consisting of type of software, file types associated with the software, expiration date, frequency of use, and date of download or installation.

14. The method of claim 13, wherein the offer of alternative software is based on the software characteristics.

15. The method of claim 1, further comprising the steps of:
installing a monitoring program on the computer system of the user; and
receiving notification of the expiration date of software on the computer system.

16. A method for detecting fee-based software on a computer of a user and offering alternative software, comprising:
using a monitoring program installed on the computer of the user to scan the computer for fee-based software;
determining the expiration date of the software based on the software characteristics selected from the group consisting of type of software, files corresponding to registration of the software by the user, file types associated with the software, frequency of use, and date of download or installation; and
offering at least one from the group consisting of replacement, complementary, and supplementary software, the offer being based on the software characteristics.

17. A system for offering alternative software, comprising:
means for scanning a computer system of a user to detect software residing on a system of the user;
means for determining an expiration date for software residing on the computer; and
means for offering the user alternative software based on the expiration date of the software.

18. The system of claim 17, further comprising:
a monitoring program for detecting the software of the user; and
means for monitoring the passage of time until the expiration date and transmitting a message to a software vendor at predetermined time intervals;
wherein the software residing on the computer was not authored by the software vendor.

19. The system of claim 18, wherein the monitoring program resides on at least one of the computer of the user, a computer network, and a computer of the software vendor.

20. The system of claim 17, wherein the means for scanning the system comprises means for detecting fee-based software.

21. The system of claim 17, further comprising means for providing the alternative software to the user in response to an affirmative response from the user.

22. The system of claim 17, further comprising means for receiving a negative response from the user and renotifying the user of the offer for the alternative software at a specified time interval from the time of the negative response.

23. The system of claim 17, further comprising a monitoring program for determining the expiration date.

24. The system of claim 23, wherein the monitoring program resides on the computer of the user and is capable of determining the expiration date by scanning at least one of: the files corresponding to registration of the software by the user, file types associated with software, and an installation date of software.

25. The system of claim 17, further comprising means for querying the user on the expiration date of software and the means for offering is adapted to offer alternative software based on a response to the query.

26. The system of claim 25, further comprising, means for receiving a negative response and renotifying the user of the offer for the alternative software at a specified time interval from the time of the negative response.

27. The system of claim 17, further comprising a database for storing information detected from the software and means for customizing an alternative software offer based on the information in the database.

28. The system of claim 27, wherein the alternative software offers is at least one of replacement software, complementary software, and supplementary software.

29. The system of claim 27, further comprising means for detecting software characteristics selected from the group consisting of type of software, file types associated with the software, expiration date, frequency of use, and date of download or installation.

30. The system of claim 29, further comprising rules for the software characteristics, the rules forming the basis for the offer of alternative software.

31. The system of claim 17, further comprising:
means for installing a monitoring program on the computer system of the user; and
means for receiving notification of the expiration date of software on the computer system.

32. A system for detecting fee-based software on a computer of a user and offering alternative software, comprising:
means for using a monitoring program installed on the computer of the user to scan the computer for fee-based software;
means for determining the expiration date of the software based on the software characteristics selected from the group consisting of type of software, files corresponding to registration of the software by the user, file types associated with the software, frequency of use, and date of download or installation; and
means for offering at least one from the group consisting of replacement, complementary, and supplementary software based, the offer being on the software characteristics.

33. A computer-readable medium for offering alternative software having computer-executable instructions for performing the steps of:
scanning a computer system of a user to detect software residing on a system of the user;
determining an expiration date for software residing on the computer; and
offering the user alternative software based on the expiration date of the software.

34. The computer-readable medium of claim 33, further comprising performing the step of monitoring the passage of time until the expiration date and transmitting a message to a software vendor at predetermined time intervals wherein the software of the user was not authored by the software vendor and is detected by a monitoring program.

35. The computer-readable medium of claim 33, further comprising performing the step of providing the monitoring program on at least one of the computer of the user, a computer network, and a computer of the software vendor, wherein the software of the user was not authored by the software vendor.

36. The computer-readable medium of claim 33, wherein the step of scanning the system comprises the step of detecting fee-based software.

37. The computer-readable medium of claim 33, further comprising, after the offering step, performing the step of providing the alternative software to the user in response to receiving an affirmative response from the user.

38. The computer-readable medium of claim 33, further comprising, after the offering step, performing the step of receiving a negative response from the user and renotifying the user of the offer for the alternative software at a specified time interval from the time of the negative response.

39. The computer-readable medium of claim 33, wherein the expiration date is determined by a monitoring program.

40. The computer-readable medium of claim 39, wherein the monitoring program resides on the computer of the user and determines the expiration date by scanning at least one of: the files corresponding to registration of the software by the user, file types associated with software, and an installation date of software.

41. The computer-readable medium of claim 33, wherein the determining step comprises querying the user on the expiration date of software, and the offering step is based on a response to the query.

42. The computer-readable medium of claim 41, further comprising, after the offering step, performing the step of receiving a negative response from the user and renotifying the user of the offer for the alternative software at a specified time interval from the time of the negative response.

43. The computer-readable medium of claim 33, further comprising performing the steps of storing information detected from the software in a database and customizing alternative software offers based on the information in the database.

44. The computer-readable medium of claim 43, wherein the offering step comprises offering at least one of replacement software, complementary software, and supplementary software.

45. The computer-readable medium of claim 43, further comprising performing the step of detecting software characteristics selected from the group consisting of type of software, file types associated with the software, expiration date, frequency of use, and date of download or installation.

46. The computer-readable medium of claim 45, wherein the offering step is based on the software characteristics.

47. The computer-readable medium of claim 33, further comprising performing the steps of:
installing a monitoring program on the computer system of the user; and
receiving notification of the expiration date of software on the computer system.

48. A computer-readable medium for detecting fee-based software on a computer of a user and offering alternative software having computer-executable instructions for performing the steps of:
using a monitoring program installed on the computer of the user to scan the computer for fee-based software;
determining the expiration date of the software based on the software characteristics selected from the group consisting of type of software, files corresponding to registration of the software by the user, file types associated with the software, frequency of use, and date of download or installation; and
offering at least one from the group consisting of replacement, complementary, and supplementary software, the offer being based on the software characteristics.
